(19) United States
(12) Patent Application Publication
(10) Pub. No.: US 2026/0037776 A1
(43) Pub. Date: Feb. 5, 2026

(54) ATTENTION NEURAL NETWORKS WITH PARTIAL POSITION ENCODING

(71) Applicant: GDM Holding LLC, Mountain View, CA (US)

(72) Inventors: Denis Teplyashin, London (GB); Nikolay Savinov, London (GB); Pranav Manjunatha, San Francisco, CA (US); Jonas Anders Adler, London (GB); Jack William Rae, London (GB)

(21) Appl. No.: 19/359,142

(22) Filed: Oct. 15, 2025

Related U.S. Application Data
(63) Continuation of application No. PCT/EP2024/058965, filed on Apr. 2, 2024.
(60) Provisional application No. 63/606,590, filed on Dec. 5, 2023.
(60) Provisional application No. 63/553,503, filed on Feb. 14, 2024.

(51) Int. Cl. G06N 3/045; G06N 3/0499

(52) U.S. Cl. CPC G06N 3/045; G06N 3/0499

(57) ABSTRACT

Methods, systems, and apparatus, including computer programs encoded on computer storage media, for processing input sequences using a neural network that uses a partial position encoding scheme. The neural network generally includes both global and local attention layers. In the partial position encoding scheme, while the local attention layers do use position encoding, (i) a subset of the global attention layers can apply an attention mechanism that does not use position encoding, or (ii) the subset of global attention layers can apply an attention mechanism that does not apply position encoding to one or more of the dimensions of the input to the attention mechanism.

### CROSS-REFERENCE TO RELATED APPLICATIONS

This application is a continuation of International Application No. PCT/EP2024/058965, filed on Apr. 2, 2024, which claims priority to U.S. Provisional Application Ser. No. 63/553,503, filed on Feb. 14, 2024, and U.S. Provisional Application Ser. No. 63/606,590, filed on Dec. 5, 2023, the entirety of which are herein incorporated by reference.

### BACKGROUND

This specification relates to processing inputs using neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current value inputs of a respective set of parameters.

### SUMMARY

This specification describes a system implemented as computer programs on one or more computers in one or more locations that processes input sequences to perform one or more machine learning tasks.

Particular embodiments of the subject matter described in this specification can be implemented so as to realize one or more of the following advantages.

This specification describes a system that processes inputs using an attention neural network that has both global and local attention layers and that operates with a partial position encoding scheme.

For example, as will be described in more detail below, in the partial position encoding scheme, while the local attention layers do use position encoding, (i) a subset of the global attention layers can apply an attention mechanism that does not use position encoding, or (ii) the subset of global attention layers can apply an attention mechanism that does not apply position encoding to one or more of the dimensions of the input to the attention mechanism. In particular, in some implementations, the subset includes all of the global attention layers in the neural network, so that (i) all of the global attention layers apply an attention mechanism that does not use position encoding, or (ii) all of the global attention layers apply an attention mechanism that does not apply position encoding to one or more of the dimensions of the input to the attention mechanism.

Attention neural networks are typically trained and deployed on devices that include one or more hardware accelerators for performing machine learning operations. Examples of such accelerators include GPUs (graphics processing units), TPUs (tensor processing units), and other ASICs. These accelerators typically have limited on-chip memory, which can require storing data off-chip during inference or otherwise bottleneck the inference process. Additionally, given the large number of training examples that are used in training an attention neural network, training on sequences that have long input lengths (large context sizes) is computationally intensive and in many cases not computationally feasible due to the limited amount of on-chip memory.

As a particular example, systems that deploy attention neural networks often maintain a so-called KV cache that caches or stores keys and values as they are computed, for later re-use. That is, once the key and value are computed for a given position in an input sequence, the system stores the key and value in a cache or other memory to avoid having to re-compute the key and value when generating outputs for later positions in the input sequence (and, during training, when backpropagating gradients through the attention neural network). This can be beneficial, but as models grow larger, and processed sequences grow longer, the gain in not having to re-compute these data is offset by the memory they consume. More particularly, the bandwidth requirements in loading data from or storing data into a KV cache can constrain the operating speed, or latency, of the entire model. It is desirable to be able to use a KV cache for processing long sequences using large models whilst somehow circumventing this memory bottleneck.

Implementations of the described techniques are able to do this.

For example, by making use of the partial position encoding scheme, the system can reduce the size of, i.e., the number of positions in, the local window for the local attention mechanisms employed by the local attention mechanisms of the local attention layers in the neural network relative to other systems that use neural networks with the same architecture while still achieving comparable or improved performance relative to these other systems.

That is, using the partial position encoding scheme allows the neural network to have a smaller local window size while still achieving comparable or improved performance relative to these other systems, i.e., other systems that use neural networks with the same architecture but without the partial position encoding scheme, i.e., neural networks that use position encoding for all layers or neural networks that use position encoding for none of the layers.

For example, the system can use a local window that includes 5×, 10×, 30×, or 50× fewer positions than other systems and still achieve comparable or better performance as a result of employing the partial position encoding scheme.

Reducing the size of the local window allows the neural network to be more computationally efficient than the other systems, both in terms of latency at inference time and memory usage at both inference and training time. An example of the relative speedup achieved by using the described techniques is shown below in FIG. 4A.

As another example, the system can reduce the amount of memory used when performing inference using the neural network, especially when keys and values or hidden states are cached as described above. An example of the reduction in memory achieved by using the described techniques is shown below in FIG. 4B.

For at least the reasons described above, it is desirable to train a neural network that can be trained on shorter context lengths and can then generalize to longer context lengths after training. By using the described techniques, this generalization to longer context lengths can be achieved without any degradation in performance for shorter context lengths, even when the local context window size is reduced.

Also, by using the described scheme, the system maintains high performance on shorter context lengths while generalizing to longer context lengths, i.e., to sequence lengths that are rarely or never encountered in the training data. For example, the system can accurately generate outputs for context lengths of 100 k tokens or greater, 200 k or greater, 300 k or greater, 500 k or greater, or even 1M or more, even if sequences of these lengths were never encountered during training of the neural network.

Thus, making use of the described scheme allows for (i) a reduced local window size, resulting in significant memory savings and inference type speed ups and (ii) generalization to longer input sequence lengths without degradation in performance on shorter sequence lengths.

This specification also describes modifications to the training of the attention neural network which, when combined with the partial position encoding scheme, further improve the performance of the attention neural network after training when processing long context length inputs.

As a particular example, by making use of the described techniques, the system can effectively achieve high accuracy across context lengths exceeding 1M tokens. This enables the language model neural network to process and reason seamlessly across mixed-modality inputs, e.g., entire books, hours of video, and tens of hours of audio.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A shows an example of processing an input sequence that includes tokens representing a video.

FIG. 1B shows an example of processing an input sequence that includes tokens representing an audio signal.

FIG. 1C is a diagram of an example neural network system and an example inference system.

FIG. 2A is a flow diagram of an example process for processing an input sequence using the neural network.

FIG. 2B is a flow diagram of another example process for processing an input sequence using the neural network.

FIG. 3 is a diagram showing a global attention head and a local attention head within the neural network.

FIG. 4A is an example chart that shows the performance of the described techniques.

FIG. 4B is another example chart that shows the performance of the described techniques.

FIG. 5 shows the performance of the described techniques on the text modality.

FIG. 6 shows an example of the performance of the described techniques on another text processing task.

FIG. 7 shows an example of the performance of the described techniques on a cross-modal data processing task.

FIG. 8 shows an example of the performance of the described techniques on another cross-modal data processing task.

Like reference numbers and designations in the various drawings indicate like elements.

### DETAILED DESCRIPTION

This specification generally describes techniques for performing machine learning tasks on input sequences using a neural network.

As will be described below, the neural network can be used to perform any of a variety of tasks that require processing an input sequence that includes a respective input token at each of a plurality of input positions to generate network output.

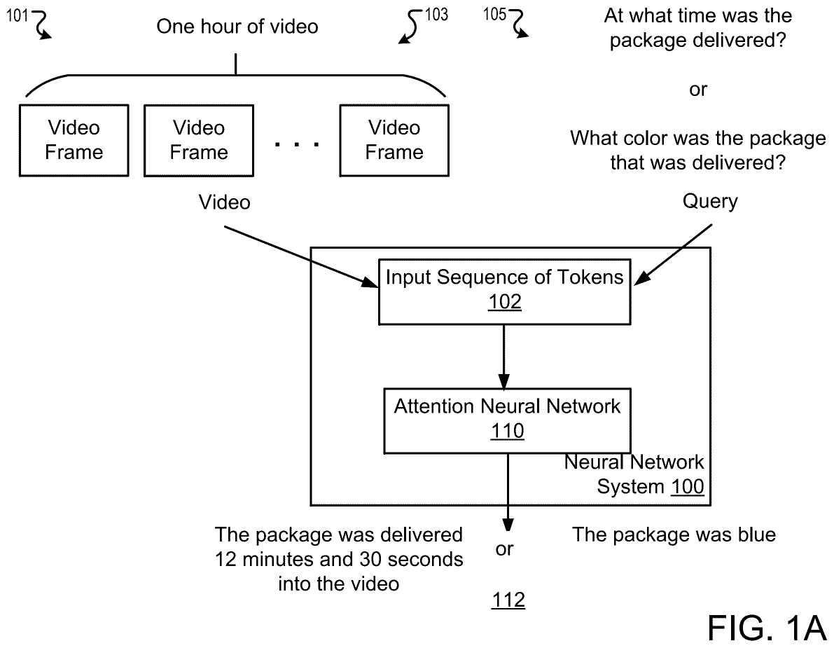

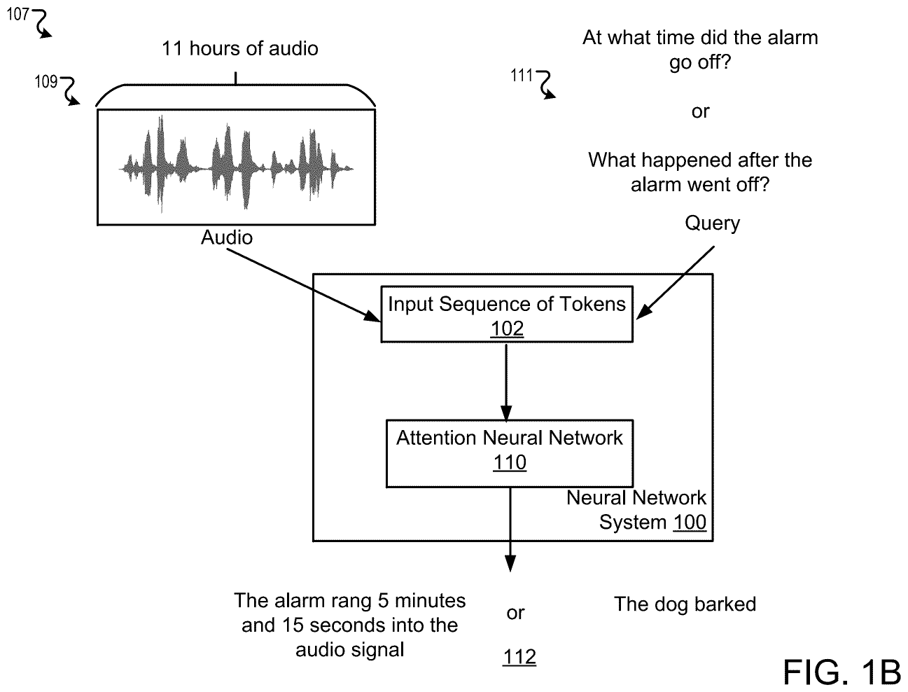

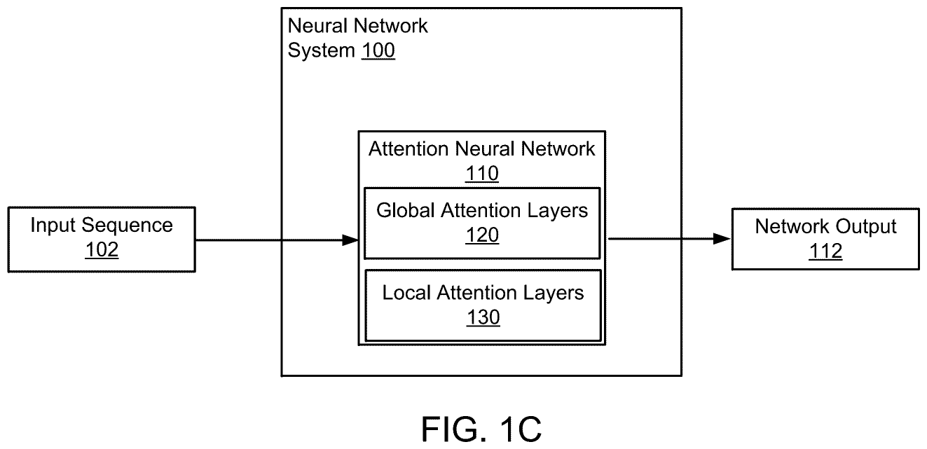

Two examples of such tasks are described with reference to FIGS. 1A and 1B, respectively. Additional examples are described with reference to FIG. 1C.

FIG. 1A shows an example 101 of processing an input sequence 102 that includes tokens representing a video using an attention neural network 110 to generate a network output 112.

As shown in FIG. 1A, a system 100 receives an input video that includes a sequence of video frames. The system 100 also receives a query about the input video. FIG. 1A shows two examples of an input query that can be received by the system 100: “at what time was the package delivered?” and “what color was the package that was delivered?”.

The system 100 processes the input video and the query to generate an input sequence 102 of input tokens. That is, the input sequence 102 includes tokens representing the video and tokens representing the query. In some cases, the tokens representing the query are followed by a separator token, e.g., a beginning of sequence token, that indicates that the neural network should start generating a response to the query.

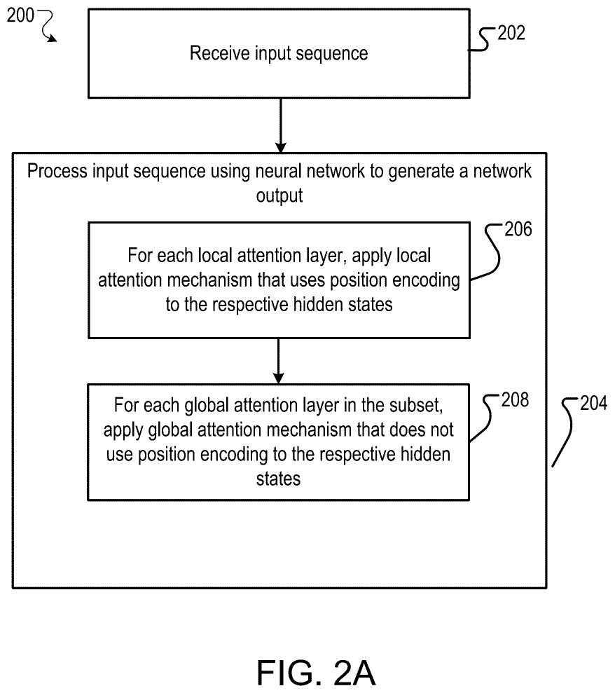

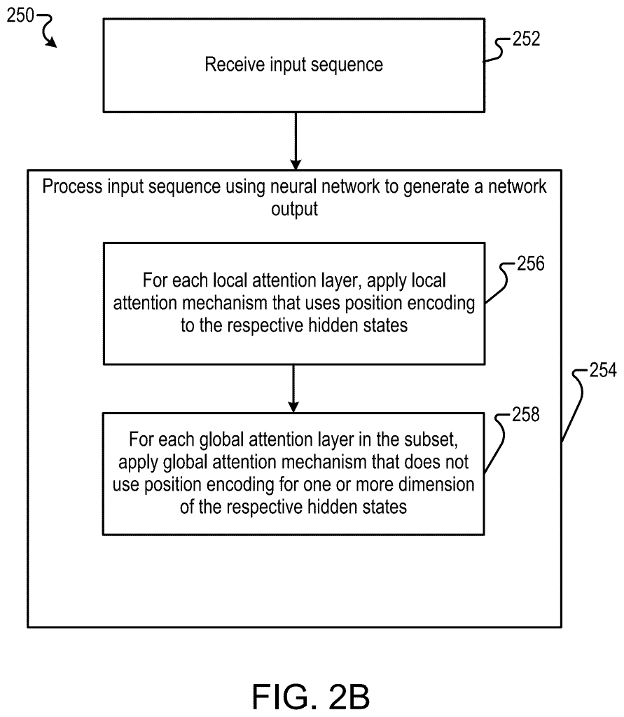

Generating tokens is described in more detail below with reference to FIG. 2A.

The system 100 processes the input sequence 102 using the neural network 110 to generate a network output 112. In the example of FIG. 1A, the network output 112 is a response to the query. In particular, FIG. 1A shows two examples of network outputs 112 that are responses to the two example queries: “the package was delivered 12 minutes and 30 seconds into the video” and “the package was blue.”

As shown in FIG. 1A, because of the architecture of the neural network 110, i.e., because the neural network 110 uses a partial position encoding scheme, because of the manner in which the neural network 110 was trained, or both, the system 100 can generate accurate network outputs 112 even when the input sequence 112 represents a video that is over an hour in length and regardless of where the information required to respond to the query is located within the video. That is, the system 110 can effectively perform the task even when it requires extracting information from an exceedingly long video context.

While FIG. 1A shows a single output sequence that includes multiple text elements, in some cases, the attention neural network 110 generates outputs auto-regressively element-by-element. Thus, in these cases the depicted text sequence is generated as a sequence of multiple network outputs 112.

FIG. 1B shows an example 103 of processing an input sequence 102 that includes tokens representing an audio signal using the neural network 110 to generate a network output 112.

As shown in FIG. 1B, the system 100 receives an input audio signal, e.g., as a sequence of amplitude values or as a spectrogram. The system 100 also receives a query about the input audio signal. FIG. 1B shows two examples of an input query that can be received by the system 100: “at what time did the alarm go off?” and “what happened after the alarm went off?”.

The system 100 processes the input audio signal and the query to generate an input sequence 102 of input tokens. That is, the input sequence 102 includes tokens representing the audio signal and tokens representing the query. In some cases, the tokens representing the query are followed by a separator token, e.g., a beginning of sequence token, that indicates that the neural network should start generating a response to the query.

The system 100 processes the input sequence 102 using the neural network 110 to generate a network output 112. In the example of FIG. 1B, the network output 112 is a response to the query. In particular, FIG. 1B shows two examples of network outputs 112 that are responses to the two example queries: “the alarm rang 5 minutes and 15 seconds into the audio signal” and “the dog barked.”

As shown in FIG. 1B, because of the architecture of the neural network 110, i.e., because the neural network 110 uses a partial position encoding scheme, because of the manner in which the neural network 110 was trained, or both, the system 100 can generate accurate network outputs 112 even when the input sequence 112 represents an audio signal that is over an hour in length and even up to eleven hours in length regardless of where the information required to respond to the query is located within the audio signal. That is, the system 110 can effectively perform the task even when it requires extracting information from an exceedingly long audio context.

FIG. 1C is a diagram of an example neural network system 100.

The neural network system 100 is an example of a system implemented as computer programs on one or more computers in one or more locations, in which the systems, components, and techniques described below can be implemented.

The neural network system 100 is a system that processes input sequences 102 to perform one or more machine learning tasks using the attention neural network 110. Generally, the input sequence 102 includes a respective input token at each of a plurality of input positions. That is, the system 100 receives an input sequence 102 and processes the input sequence 102 using the neural network 110 to generate a network output 112.

The neural network 110 can be configured through training to perform any kind of machine learning task, i.e., can be configured to receive any kind of input sequence and to generate any kind of score, classification, or regression output based on the input sequence.

In some situations, the neural network 110 can be referred to as an auto-regressive neural network, i.e., because the neural network auto-regressively generates an output sequence of tokens. More specifically, the auto-regressively generated output is created by generating each particular token in the output sequence conditioned on a current input sequence that includes at least some of the tokens that precede the particular token in the output sequence, i.e., the tokens that have already been generated for any previous positions in the output sequence that precede the particular position of the particular token.

For example, the neural network 110 can be an auto-regressive attention neural network that includes (i) a plurality of attention blocks that each apply a self-attention operation and (ii) an output subnetwork that processes an output of the last attention block to generate the score distribution, e.g., a score distribution used for selecting an output token, e.g., by sampling from the score distribution or selecting a most likely token according to the score distribution.

In this example, the neural network can have any of a variety of Transformer-based neural network architectures. Examples of such architectures include those described in J. Hoffmann, S. Borgeaud, A. Mensch, E. Buchatskaya, T. Cai, E. Rutherford, D. d. L. Casas, L. A. Hendricks, J. Welbl, A. Clark, et al. Training compute-optimal large language models, arXiv preprint arXiv:2203.15556, 2022; J. W. Rae, S. Borgeaud, T. Cai, K. Millican, J. Hoffmann, H. F. Song, J. Aslanides, S. Henderson, R. Ring, S. Young, E. Rutherford, T. Hennigan, J. Menick, A. Cassirer, R. Powell, G. van den Driessche, L. A. Hendricks, M. Rauh, P. Huang, A. Glaese, J. Welbl, S. Dathathri, S. Huang, J. Uesato, J. Mellor, I. Higgins, A. Creswell, N. McAleese, A. Wu, E. Elsen, S. M. Jayakumar, E. Buchatskaya, D. Budden, E. Sutherland, K. Simonyan, M. Paganini, L. Sifre, L. Martens, X. L. Li, A. Kuncoro, A. Nematzadeh, E. Gribovskaya, D. Donato, A. Lazaridou, A. Mensch, J. Lespiau, M. Tsimpoukelli, N. Grigorev, D. Fritz, T. Sottiaux, M. Pajarskas, T. Pohlen, Z. Gong, D. Toyama, C. de Masson d'Autume, Y. Li, T. Terzi, V. Mikulik, I. Babuschkin, A. Clark, D. de Las Casas, A. Guy, C. Jones, J. Bradbury, M. Johnson, B. A. Hechtman, L. Weidinger, I. Gabriel, W. S. Isaac, E. Lockhart, S. Osindero, L. Rimell, C. Dyer, O. Vinyals, K. Ayoub, J. Stanway, L. Bennett, D. Hassabis, K. Kavukcuoglu, and G. Irving. Scaling language models: Methods, analysis & insights from training gopher. CoRR, abs/2112.11446, 2021; Colin Raffel, Noam Shazeer, Adam Roberts, Katherine Lee, Sharan Narang, Michael Matena, Yanqi Zhou, Wei Li, and Peter J Liu. Exploring the limits of transfer learning with a unified text-to-text transformer. arXiv preprint arXiv:1910.10683, 2019; Daniel Adiwardana, Minh-Thang Luong, David R. So, Jamie Hall, Noah Fiedel, Romal Thoppilan, Zi Yang, Apoorv Kulshreshtha, Gaurav Nemade, Yifeng Lu, and Quoc V. Le. Towards a human-like open-domain chatbot. CoRR, abs/2001.09977, 2020; and Tom B Brown, Benjamin Mann, Nick Ryder, Melanie Subbiah, Jared Kaplan, Prafulla Dhariwal, Arvind Neelakantan, Pranav Shyam, Girish Sastry, Amanda Askell, et al. Language models are few-shot learners. arXiv preprint arXiv:2005.14165, 2020.

More specifically, the neural network 110 includes a plurality of layers that include a plurality of attention layers.

Each attention layer receives a respective hidden state for each of the input positions in the input sequence 102 and updates the respective hidden states for each of the input positions by applying an attention mechanism to the respective hidden states. That is, each hidden state corresponds to a respective input token within the input sequence, i.e., the hidden state for a given input position corresponds to the token at the given input position.

For the first attention layer in the neural network 110, the respective hidden states can be the input tokens in the input sequence or the input tokens after having been modified by one or more initial layers of the neural network. For the subsequent attention layers in the sequence, the respective hidden states can be the outputs of a preceding layer within the attention neural network 110.

Some of the plurality of attention layers are global attention layers 120 while others are local attention layers 130.

Each global attention layer 120 applies a global attention mechanism that, for each of the plurality of input positions, attends over all of the input positions preceding or equal to the input position in the input sequence.

The global attention mechanisms applied by the global attention layers can be dense attention mechanisms or sparse attention mechanisms.

A “dense” attention mechanism is one that, for any given input position, assigns non-zero attention weights to (at least) a large proportion of the input positions preceding or equal to the given input position in the input sequence. For example, a majority of the attention weights may be non-zero, 90% of the weights may be non-zero, or all of the weights may be non-zero.

A “sparse” attention mechanism is one that, for any given input position, is constrained to only assign non-zero attention weights to a relatively small proportion of the input positions preceding or equal to the given input position in the input sequence. For example, in a sparse attention mechanism, a majority of the attention weights may be zero.

Each local attention layer 130, on the other hand, applies a local attention mechanism that, for each of the plurality of input positions, attends only over a set of local input positions that are within a local window of the input position in the input sequence.

That is, unlike the global attention mechanisms, the local attention mechanism does not attend to any position that is outside of the local window of the input position.

The local windows are generally “causal,” so that, for any given input position, they include up to a fixed number of input positions that are closest to the given input position and that precede or are equal to the given input position, but not any input positions that are after the given input position in the input sequence.

The fixed number of input positions is generally much smaller than the total number of positions in the input sequence and is referred to as the size of the context window.

Additionally, because the neural network 110 operates with a partial position encoding scheme (as will be described in more detail below), the context windows for the local attention layers 130 can have a smaller size relative to other attention neural networks that make use of both local and global attention layers while still maintaining high-quality performance, i.e., performance that matches or exceeds that of the other attention neural networks.

More specifically, the size of the local context window can be smaller both in terms of absolute numbers of positions in the context window and in terms of the relative size of local window size relative to the size of the input sequence.

For example, the number of positions in the local window can be greater than or equal to 128 but less than or equal to 4096. In some cases, the number of positions in the local window can be smaller, e.g., greater than or equal to 128 but less than or equal to 2048, greater than or equal to 128 but less than or equal to 1024, or even greater than or equal to 64 but less than or equal to 512. As a specific example, the system can still maintain high-quality performance when the number of positions in the local window is 512.

As another example, the number of positions in the local window can be greater than or equal to 0.1% but less than or equal to 1.6% of a number of positions in the input sequence. In some cases, the number of positions can be smaller, e.g., greater than or equal to 0.1% but less than or equal to 0.8% of the number of positions in the input sequence or even greater than or equal to 0.1% but less than or equal to 0.4% of the number of positions in the input sequence.

As indicated above and unlike conventional attention neural networks, the neural network 110 operates with a partial position encoding scheme, i.e., so not all of the attention layers within the neural network apply position encoding to all of the dimensions of the respective inputs to the attention layers.

In particular, for each of the local attention layers 130, the respective local attention mechanism applied by the local attention layer 130 applies position encoding. In other words, all of the local attention layers 130 apply position encoding as part of applying their corresponding local attention mechanism.

“Position encoding” refers to modifying the operations applied by the attention layer for a given input position based on the absolute or relative position of the input position within the input sequence.

For example, the position encoding can be Rotary Position Embedding (RoPE) position encoding or a different type of position encoding, e.g., an Attention with Linear Biases (ALiBi) position encoding.

In general applying position encoding at an attention layer rather than applying position encoding, e.g., at the neural network input, or not applying position encoding involves using additional information at the attention layer that identifies the relative or absolute positions of hidden states that are received as input by the attention layer. The position of a hidden state generally refers to the input position within the input sequence of the input token to which the hidden state corresponds.

For the global attention layers 120, however, not all of the attention layers within the neural network apply position encoding to all of the dimensions of the respective inputs to the global attention layers.

In particular, either (i) the respective global attention mechanisms applied by each global attention layer 120 in a subset that includes one or more of the plurality of global attention layers do not apply position encoding or (ii) the respective global attention mechanisms applied by each global attention layer 120 in the subset do not apply position encoding to one or more of the plurality of dimensions (but do apply position encoding to the remaining dimensions).

Thus, for prong (i), the respective global attention mechanisms applied by each global attention layer 120 in the subset apply a global attention mechanism that attends over the hidden states independent of the positions of the hidden states (within the input sequence).

In some implementations, the subset includes all of the global attention layers 120. In this case, for prong (i), the respective global attention mechanisms applied by all of global attention layers 120 in the neural network do not apply position encoding, i.e., none of the global attention layers in the neural network apply position encoding.

Thus, the neural network 110 operates with a modified (“partial”) position encoding scheme where the local attention layers 310 employ position encoding, but at least some of the global attention layers 120 do not apply position encoding to at least some (and, in some cases, to any) of the input positions.

Generally, to apply the self-attention operation, each attention mechanism uses one or more attention heads.

Each attention head generates a set of queries, a set of keys, and a set of values, and then applies any of a variety of variants of query-key-value (QKV) attention, e.g., a dot product attention function or a scaled dot product attention function, using the queries, keys, and values to generate an output.

As a particular example, in an attention head of a self-attention neural network layer, the attention mechanism may be configured to apply each of a query transformation, e.g., defined by a matrix W^{Q}, a key transformation, e.g., defined by a matrix W^{K}, and a value transformation, e.g., defined by a matrix W^{V}, to the attention layer input for each hidden state of an input sequence X to derive a respective query vector Q=XW^{Q}, key vector K=XW^{K}, and value vector V=XW^{V} which are used determine the updated hidden state. For example, the attention head can generate an updated hidden state for each input position computing a weighted sum of the values, weighted by a similarity function of the query for the input position to the corresponding key. The similarity function may comprise, e.g., a dot product, cosine similarity, or other similarity measure.

When the attention head uses position encoding, the application of the dot product attention function, the computation of the queries, keys, and values, or both depend on the relative or absolute positions of the hidden states corresponding to the queries, keys, and values within the input sequence.

For example, an implementation of RoPE can involve determining, for a given query at a respective input position, a query rotation matrix that represents the absolute or relative position of the respective input position of the query, e.g., an index of the input position in the sequence; determining, for a given key at a respective input position, a key rotation matrix that similarly represents the absolute or relative position of the respective input position of the key, e.g., an index of the input position in the sequence, and multiplicatively combining the query rotation matrix, the key rotation matrix, the query (vector), and the key (vector), to determine a weight value between the query and the key that is dependent on a relative distance between the position corresponding to the key and the position corresponding to the query.

As another example, an implementation of ALiBi can involve adding a linear bias matrix to a weight determined from a combination of the key and the query.

When the attention head does not use position encoding, both the application of the dot product attention function and the computation of the queries, keys, and values, are independent of the relative or absolute positions of the hidden states corresponding to the queries, keys, and values within the input sequence.

Each query, key, value can be a vector that includes one or more vector elements. When there are multiple attention heads, the attention block then combines the outputs of the multiple attention heads, e.g., by concatenating the outputs and, optionally, processing the concatenated outputs through a linear layer.

For local attention mechanisms, for each position, the positions that are used to generate the queries, keys, and values for the position are defined by the local window size for the local attention mechanism, i.e., non-zero attention weights for a given position are computed only for positions that are within the local window of the given position.

In some cases, because the attention applied by the attention layers is causal, the system 100 can store, for any given attention mechanism and when generating the output for any given input position, the hidden states or the keys and values already computed for earlier input positions steps rather than re-computing the hidden states (or the keys and values) for earlier time steps.

Thus, in these cases, updating the respective hidden states for each of the input positions by applying an attention mechanism to the respective hidden states refers to updating the respective hidden state for the last input position in the current input sequence using keys and values or hidden states for the other input positions that have been retrieved from memory (e.g., from a “cache”). Storing keys and values in a memory for later re-use will generally be referred as storing the keys and values in a “KV cache.”

The global attention layers 120 and the local attention layers 130 can generally be arranged within the neural network 110 in any appropriate configuration. For example, the layers can be arranged in a sequence and each global attention layer 120 can be preceded by a respective subset of the local attention layers 130 in the sequence of layers. For example, every other, every third, every fourth, or every eighth attention layer can be a global attention layer 120.

The layers in the neural network 110 can also include other types of layers, e.g., normalization layers, residual connection layers, feedforward layers, and so on.

In some cases, some or all of the feedforward layers in the neural network are implemented as sparse mixture of experts (MoE) layers while in other cases all the feedforward layers are dense feedforward layers.

A MoE layer may be one that includes multiple “experts”, each expert including one or more neural network layers, e.g., feedforward layers.

A MoE layer is generally equipped with a router that routes an input to the MoE layer, e.g., each hidden state in a set of hidden states received by the MoE layer, to one or more selected experts, with the output of the MoE layer for a given input being generated by combining the outputs generated by the selected experts or, when there is only one selected expert, using the output of the selected expert as the output. The MoE layer can optionally be followed by a normalization layer, a residual connection layer, or both,

A sparse MoE layer is one in which the router routes any given input to only a small fraction, e.g., less than half, of the experts, so that only the small fraction of experts is active for the processing of any given input.

More particularly a method as described herein can be performed on a combination of a host processor, such as a general purpose computing system, and one or more hardware neural network accelerators, such as one or more TPUs, GPUs, or other machine learning accelerators. Typically such accelerators include hardware to perform matrix multiplication and memory, although this may be less than the memory capacity of the host processor.

In some implementations, the system 100 performs the processing of an input sequence 102 using the attention neural network 110 by making use of a combination of a host processor, such as a general purpose computing system that includes one or more CPUs, and one or more hardware neural network accelerators, such as one or more TPUs, GPUs, or other machine learning accelerators. Typically such accelerators include hardware to perform matrix multiplication and memory (“on-chip memory”). The memory capacity of the on-chip memory is generally less than the memory capacity of the host processor (“off-chip memory”).

As an example of how the system 100 can use the combination of the host processor and the one or more accelerators, the system 100 can load values for a set of weights or other learned parameters for the neural network 110, from the host processor into memory of the one or more hardware accelerators. The input sequence 102 is then processed using the plurality of attention layers, each implemented on the one or more hardware accelerators, (and using the other layers in the neural network 110, if any) to generate a network output 112. For example, the network output 112 can include an auto-regressively generated output sequence in which each particular output token in the output sequence is conditioned on a current input sequence that includes at least some of the output tokens that precede the particular token in the output sequence.

During processing of the input sequence 102, a KV cache is maintained for some or all of the attention layers on the one or more hardware accelerators, by the host processor, or both.

The KV cache includes stored keys and values generated by the attention heads of (the) some or all of the plurality of attention layers, for use in applying an attention mechanism of an attention layer (or layers) to a respective hidden state input to update the respective hidden state for a last input position in the current input sequence.

When the KV cache is maintained on the hardware accelerators, i.e., in on-chip memory, because the described techniques enable use of a local window with reduced size, the KV cache needs to store fewer keys and values, thereby consuming less of the limited memory capacity of the on-chip memory and, in some cases, allowing the KV cache to fit in on-chip memory (when KV caches for conventional neural networks could not fit because of the larger size of the local window).

When the KV cache is maintained on the host computer, e.g., because the KV cache cannot fit in on-chip memory, because the described techniques enable use of a local window with reduced size, the KV cache needs to store fewer keys and values, thereby reducing the amount of off-chip data that needs to be transmitted on-chip in order to perform the processing of the neural network 110, i.e., thereby consuming less of the available data communication bandwidth.

Thus, the described techniques can mitigate the impact of the typically limited memory on a hardware accelerator, thus overcoming the memory bandwidth bottleneck and facilitating fast processing of long sequences with little or no impact on the quality of the output.

Some examples of machine learning tasks that a neural network 110 when implemented using one of the architectures described above or other known architectures can be configured to perform follow.

In any of the implementations below, the neural network may be deployed as part of a chat bot, dialogue agent, or other software tool that receives inputs from users and provides outputs in response to the received input, e.g., as part of a conversation or dialogue. In these implementations, the input sequences received by the neural network are (generated from) user inputs and the output sequences generated by the neural network can be used to generate responses to the user inputs.

In implementations the neural network may be configured as, or include, a generative (large) language model or a multi-modal model, e.g., a visual and language model, to perform these example machine learning tasks.

In some cases, the neural network is a neural network that is configured to perform an image processing task, i.e., receive an input image and to process the input image to generate a network output for the input image. For example the input sequence may comprise tokens representing pixel values for pixels in regions or patches of the image. For example, the task may be image classification and the output generated by the neural network for a given image may be scores for each of a set of object categories, with each score representing an estimated likelihood that the image contains an image of an object belonging to the category. As another example, the task can be image embedding generation and the output generated by the neural network can be a numeric embedding of the input image. As yet another example, the task can be object detection and the output generated by the neural network can identify locations in the input image at which particular types of objects are depicted. As yet another example, the task can be image segmentation and the output generated by the neural network can assign each pixel of the input image to a category from a set of categories. In some other cases, the neural network is a neural network that is configured to perform an image generation task, where the input is a conditioning input and the output is a sequence of intensity value inputs for the pixels of an image.

As one example, the task may be a neural machine translation task. For example, if the input to the neural network is a sequence of text, e.g., a sequence of words, phrases, characters, or word pieces, in one language, the output generated by the neural network may be a translation of the sequence of text into another language, i.e., a sequence of text in the other language that is a translation of the input sequence of text. The vocabulary for the input tokens may be words, wordpieces or characters of the first language, and the vocabulary for the output tokens may be words, wordpieces or characters of the other language. As a particular example, the task may be a multi-lingual machine translation task, where a single neural network is configured to translate between multiple different source language—target language pairs. In this example, the source language text may be augmented with an identifier that indicates the target language into which the neural network should translate the source language text.

Some implementations may be used for automatic code generation. For example the input tokens may represent words, wordpieces or characters in a first natural language and the output tokens may represent instructions in a computer programming or markup language, or instructions for controlling an application program to perform a task, e.g., build a data item such as an image or web page.

As another example, the task may be an audio processing task. For example, if the input to the neural network is a sequence representing a spoken utterance, the output generated by the neural network may be a score for each of a set of pieces of text, each score representing an estimated likelihood that the piece of text is the correct transcript for the utterance, e.g. a speech to text task. As another example, if the input to the neural network is a sequence representing a spoken utterance, the output generated by the neural network can indicate whether a particular word or phrase (“hotword”) was spoken in the utterance. As another example, if the input to the neural network is a sequence representing a spoken utterance, the output generated by the neural network can be a classification of the spoken utterance into one of a plurality of categories, for example an identity of the natural language in which the utterance was spoken.

As another example, the task can be a natural language processing or understanding task, e.g., an entailment task, a paraphrase task, a textual similarity task, a sentiment task, a sentence completion task, a grammaticality task, and so on, that operates on a sequence of text in some natural language.

As another example, the task can be a text to speech task, where the input is text in a natural language or features of text in a natural language and the network output is a spectrogram, a waveform, or other data defining audio of the text being spoken in the natural language.

As another example, the task can be a health prediction task, where the input is a sequence derived from electronic health record data for a patient and the output is a prediction that is relevant to the future health of the patient, e.g., a predicted treatment that should be prescribed to the patient, the likelihood that an adverse health event will occur to the patient, or a predicted diagnosis for the patient. Such electronic health data may, for example, comprise one or more sequences of physiological data taken from a patient, with the output being a corresponding prediction that relates to those sequences of data. Examples of physiological data and a corresponding prediction include: blood glucose measurements, with the prediction being a predicted future blood glucose measurement or the prediction of a hyper- or hypo-glycemic event; a heart rate, with the prediction being the presence or absence of a heart condition, or a future cardiac event; blood pressure measurements, with the prediction being the risk of a future heart condition; or the like.

As another example, the task can be a text generation task, where the input is a sequence of text, and the output is another sequence of text, e.g., a completion of the input sequence of text, a response to a question posed in the input sequence, or a sequence of text that is about a topic specified by the first sequence of text. As another example, the input to the text generation task can be an input other than text, e.g., an image, and the output sequence can be text that describes the input.

In some implementations the input sequence represents data to be compressed, e.g., image data, text data, audio data, or any other type of data; and the output sequence a compressed version of the data. The input and output tokens may each comprise any representation of the data to be compressed/compressed data, e.g., symbols or embeddings generated/decoded by a respective neural network. In some complementary implementations the input sequence represents compressed data and the output sequence represents a decompressed version of the data, e.g., image data, text data, audio data, or any other type of data.

As another example, the task can be an agent control task, where the input is a sequence of observations or other data characterizing states of an environment and the output defines an action to be performed by the agent in response to the most recent data in the sequence. The agent can be, e.g., a real-world or simulated robot, a control system for an industrial facility, or a control system that controls a different kind of agent. The observations may comprise sensor data captured by sensors associated with (e.g., part of) the agent, for example visual data, LIDAR data, sonar data, agent configuration data (e.g., joint angles), agent orientation data, or the like.

In some implementations, the environment is a real-world environment, the agent is a mechanical (or electro-mechanical) agent interacting with the real-world environment, e.g., a robot or an autonomous or semi-autonomous land, air, or sea vehicle operating in or navigating through the environment, and the actions are actions taken by the mechanical agent in the real-world environment to perform the task. For example, the agent may be a robot interacting with the environment to accomplish a specific task, e.g., to locate or manipulate an object of interest in the environment or to move an object of interest to a specified location in the environment or to navigate to a specified destination in the environment.

In these implementations, the observations may include, e.g., one or more of: images, object position data, and sensor data to capture observations as the agent interacts with the environment, for example sensor data from an image, distance, or position sensor or from an actuator. For example in the case of a robot, the observations may include data characterizing the current state of the robot, e.g., one or more of: joint position, joint velocity, joint force, torque or acceleration, e.g., gravity-compensated torque feedback, and global or relative pose of an item held by the robot. In the case of a robot or other mechanical agent or vehicle the observations may similarly include one or more of the position, linear or angular velocity, force, torque or acceleration, and global or relative pose of one or more parts of the agent. The observations may be defined in 1, 2 or 3 dimensions, and may be absolute and/or relative observations. The observations may also include, for example, sensed electronic signals such as motor current or a temperature signal; and/or image or video data for example captured by a camera or a LIDAR sensor, e.g., data from sensors of the agent or data from sensors that are located separately from the agent in the environment.

In these implementations, the actions may be control signals to control the robot or other mechanical agent, e.g., torques for the joints of the robot or higher-level control commands, or the autonomous or semi-autonomous land, air, sea vehicle, e.g., torques to the control surface or other control elements, e.g., steering control elements of the vehicle, or higher-level control commands. The control signals can include for example, position, velocity, or force/torque/acceleration data for one or more joints of a robot or parts of another mechanical agent. The control signals may also or instead include electronic control data such as motor control data, or more generally data for controlling one or more electronic devices within the environment the control of which has an effect on the observed state of the environment. For example in the case of an autonomous or semi-autonomous land or air or sea vehicle the control signals may define actions to control navigation, e.g., steering, and movement e.g., braking and/or acceleration of the vehicle.

In some implementations the environment is a simulation of the above-described real-world environment, and the agent is implemented as one or more computers interacting with the simulated environment. For example, a system implementing the neural network may be used to select actions in the simulated environment during training or evaluation of the system and, after training, or evaluation, or both, are complete, the action selection policy may be deployed for controlling a real-world agent in the particular real-world environment that was the subject of the simulation. This can avoid unnecessary wear and tear on and damage to the real-world environment or real-world agent and can allow the control neural network to be trained and evaluated on situations that occur rarely or are difficult or unsafe to re-create in the real-world environment. For example the system may be partly trained using a simulation of a mechanical agent in a simulation of a particular real-world environment, and afterwards deployed to control the real mechanical agent in the particular real-world environment. Thus in such cases the observations of the simulated environment relate to the real-world environment, and the selected actions in the simulated environment relate to actions to be performed by the mechanical agent in the real-world environment.

In some implementations, as described above, the agent may not include a human being (e.g., it is a robot). Conversely, in some implementations the agent comprises a human user of a digital assistant such as a smart speaker, smart display, or other device. Then the information defining the task can be obtained from the digital assistant, and the digital assistant can be used to instruct the user based on the task.

For example, a system implementing the neural network may output to the human user, via the digital assistant, instructions for actions for the user to perform at each of a plurality of time steps. The instructions may for example be generated in the form of natural language (transmitted as sound and/or text on a screen) based on actions chosen by the system. The system chooses the actions such that they contribute to performing a task. A monitoring system (e.g., a video camera system) may be provided for monitoring the action (if any) which the user actually performs at each time step, in case (e.g., due to human error) it is different from the action which the system instructed the user to perform. Using the monitoring system the system can determine whether the task has been completed. The system may identify actions which the user performs incorrectly with more than a certain probability. If so, when the system instructs the user to perform such an identified action, the system may warn the user to be careful. Alternatively or additionally, the system may learn not to instruct the user to perform the identified actions, i.e., ones which the user is likely to perform incorrectly.

More generally, the digital assistant instructing the user may comprise receiving, at the digital assistant, a request from the user for assistance and determining, in response to the request, a series of tasks for the user to perform, e.g., steps or sub-tasks of an overall task. Then for one or more tasks of the series of tasks, e.g., for each task, e.g., until a final task of the series the digital assistant can be used to output to the user an indication of the task, e.g., step or sub-task, to be performed. This may be done using natural language, e.g., on a display and/or using a speech synthesis subsystem of the digital assistant. Visual, e.g., video, and/or audio observations of the user performing the task may be captured, e.g., using the digital assistant. A system as described above may then be used to determine whether the user has successfully achieved the task, e.g., step or sub-task, i.e., from the answer as previously described. If there are further tasks to be completed the digital assistant may then, in response, progress to the next task (if any) of the series of tasks, e.g., by outputting an indication of the next task to be performed. In this way the user may be led step-by-step through a series of tasks to perform an overall task. During the training of the neural network, training rewards may be generated, e.g., from video data representing examples of the overall task (if corpuses of such data are available) or from a simulation of the overall task.

In a further aspect there is provided a digital assistant device including a system as described above. The digital assistant can also include a user interface to enable a user to request assistance and to output information. In implementations this is a natural language user interface and may comprise a keyboard, voice input-output subsystem, and/or a display. The digital assistant can further include an assistance subsystem configured to determine, in response to the request, a series of tasks for the user to perform. In implementations this may comprise a generative (large) language model, in particular for dialog, e.g., a conversation agent such as Sparrow (Glaese et al. arXiv:2209.14375) or Chinchilla (Hoffmann et al. arXiv:2203.15556). The digital assistant can have an observation capture subsystem to capture visual and/or audio observations of the user performing a task; and an interface for the above-described language model neural network (which may be implemented locally or remotely). The digital assistant can also have an assistance control subsystem configured to assist the user. The assistance control subsystem can be configured to perform the steps described above, for one or more tasks, e.g., of a series of tasks, e.g., until a final task of the series. More particularly the assistance control subsystem and output to the user an indication of the task to be performed, capture, using the observation capture subsystem, visual or audio observations of the user performing the task, determine from the above-described answer whether the user has successfully achieved the task. In response the digital assistant can progress to a next task of the series of tasks and/or control the digital assistant, e.g., to stop capturing observations.

As another example, the task can be a genomics task, where the input is a sequence representing a fragment of a DNA sequence or other molecule sequence and the output is either an embedding of the fragment for use in a downstream task, e.g., by making use of an unsupervised learning technique on a data set of DNA sequence fragments, or an output for the downstream task. Examples of downstream tasks include promoter site prediction, methylation analysis, predicting functional effects of non-coding variants, and so on.

In some cases, the machine learning task is a combination of multiple individual machine learning tasks, i.e., the system is configured to perform multiple different individual machine learning tasks, e.g., two or more of the machine learning tasks mentioned above. For example, the system can be configured to perform multiple individual natural language understanding tasks, with the network input including an identifier for the individual natural language understanding task to be performed on the network input.

In some cases, the machine learning task is a multi-modal processing task that requires processing multi-modal data. In general, multi-modal data is a combination of two or more different types of data, e.g., two or more of audio data, image data, text data, or graph data. As one example the multi-modal data may comprise audio-visual data, comprising a combination of pixels of an image or of video and audio data representing values of a digitized audio waveform. As another example the multi-modal data may comprise a combination of i) text data representing text in a natural language and ii) pixels of an image or of video or audio data representing values of an audio waveform. Optionally, but not necessarily, the different types of data may represent the same or overlapping objects using the different modalities (types), and when processing multi-modal data the data may be mapped into a common embedding space.

As a particular example, the task is a multi-modal processing task that requires processing both text and image inputs, so that the neural network includes both a computer vision neural network and a text processing neural network. That is, the target output to be generated by the computer vision neural network for a given image depends on one or more outputs generated by the text processing neural network for one or more corresponding text inputs (and vice versa). Examples of such tasks include open-vocabulary image classification, open-vocabulary object detection, image captioning, text-based image search, image-based retrieval, and so on.

As some further examples a multi-modal processing task can involve processing a text input comprising a sequence of text or audio data representing values of an audio waveform, e.g., instantaneous amplitude data or time-frequency domain data, or an image or video (or encoded versions of these inputs) to generate the network output. The network output may comprise any form of output appropriate to the task performed. For example the network output may comprise text in a natural or computer language that defines a result of the task, e.g., for tasks such as image captioning, video or audio question answering (answering a natural language question about a visual or audio input), or object detection or instance segmentation. For example in a video or audio question answering task the question can define an information content extraction task, to extract information from the content of the video or audio, or the question can define a reasoning task such as a predictive reasoning task (e.g. “what would happen next?”), a counterfactual reasoning task (e.g. “what would happen if.?”), or a causal reasoning task (e.g. “why did X happen?”). The network output can provide an answer in any convenient form, e.g. tokens representing natural language. An input to the system may be obtained from a sensor sensing the real world, e.g. a a condition or characteristic of the real world. For example the video or audio may be captured from the real-world. The network output can then provide an answer, e.g. in natural language, to a question asked about the real-world input.

Also or instead the network output may comprise data defining an image, video or audio object, e.g., as specified by the input (e.g. by a natural language description of one or more characteristics of the object), e.g., in a generative task. As a further alternative the network output may comprise non-textual action selection data for selecting an action to be performed by an agent controlled by the network output, e.g. as described above, e.g. in response to an input that includes a natural language description of a physical or other task to be performed by the agent. As another example the network output may also or instead define an intermediate step to be performed during the task, e.g., a call to a software API for a software tool that is used when performing the task; the input may then receive an output from the software tool that is used to generate a final network output that performs the task.

More generally, the multi-modal processing task may correspond to any of the tasks previously described for any of the types of data making up the multi-modal combination. For example, an accuracy of the previously described tasks may be increased when the task is applied to multi-modal data combining the data for which the task has been previously described and another type of data. For example detection or classification of an object or event may be improved when data of multiple different types (modalities) is processed.

More generally, the task to be performed by the neural network can be specified by the input sequence. As a particular example, the input sequence can include a prompt or an instruction that specifies the task that is to be performed by the neural network. Optionally, in this example, the input sequence also includes context for performing the task.

In general in implementations of the described techniques the input data, e.g., text, audio, and/or an image or video, may be encoded into a sequence of input tokens in any convenient manner; and output tokens may be similarly decoded into text, audio, and/or image or video data according to the particular task or tasks to be performed.

Examples of generating an input sequence that includes tokens of multiple modalities will be described in more detail below.

Prior to using the neural network 110 to process input sequences the system 100 or another training system trains the neural network 110.

The training system, i.e., the system 100 or the other training system, can train the neural network 110 using any of a variety of training techniques.

For example, the training system can train the neural network through one or more of unsupervised learning, e.g., a language modeling objective, supervised learning, e.g., supervised fine-tuning, instruction tuning, direct preference optimization, and so on, or reinforcement learning, e.g., reinforcement learning from human or AI feedback, and so on.

Because the neural network 110 uses the partial positioning encoding scheme, the neural network 110 can effectively generalize to longer input sequence 102 after training.

For example, when, the neural network 110 has been trained using a plurality of training input sequences, the number of tokens in a given input sequence 102 that is processed after training can be greater than the number of tokens in a majority of the plurality of training input sequences (while still generating a high-quality output). As a particular example, the number of tokens in the input sequence 102 can be greater than the number of tokens in 90% of the plurality of training input sequences. As another particular example, the number of tokens in the input sequence 102 can be greater than the number of tokens in all of the plurality of training input sequences. That is, because of the use of the partial position encoding scheme, the neural network 110 can effectively process input sequences 102 that are longer than any training input sequence that was seen during the training of the neural network 110.

In some implementations, the system 100 modifies the training of the neural network 110 to improve the performance of the neural network 110 after training, i.e., to improve the impact of the position encoding scheme.

For example, the neural network 110 can have been trained over a sequence of a plurality of training phases. During one or more final training phases in the sequence, the training system can have dropped out one or more separator tokens from input training sequences with a specified probability. “Dropping out” a token can refer to removing the token from the sequence prior to processing by the neural network 110 or to setting the token to random values or zeroes.

For example, the plurality of training phases can include a set of phases corresponding to unsupervised pre-training. In this example, the final training phases can be one or more final phases of the unsupervised pre-training.

As another example, the plurality of training phases can include a set of phases corresponding to unsupervised pre-training, followed by supervised fine-tuning, reinforcement learning fine-tuning, or both. In this example, the final training phases can include one or more phases from supervised fine-tuning, reinforcement learning fine-tuning, or both.

For example, each training phase can correspond to training the neural network on a specified subset of a larger set of training input sequences. Thus, the one or more training phases can correspond to training the neural network on the final 10%, 20%, or 30% of the training sequences in the larger set.

During each training phase, the system performs multiple training iterations.

At each training iteration, the system can receive a set of training input sequences for the training iteration.

For each of the set of training input sequences, the system can process the training input sequence using the neural network to generate a respective prediction for each of one or more positions within the training sequence. For example, when the training input sequence includes an original input sequence and an original output sequence, the predictions can be the probabilities assigned to the output tokens within the original output sequence by the neural network during the processing of the training sequence. That is, for an output token that is part of the original output sequence and is located at position j within a training sequence, the prediction can be the probability assigned to the output token conditioned on the tokens at positions j−1 and earlier within the original output sequence.

The system determines a respective loss from the respective predictions, e.g., a perplexity-based loss, a negative log likelihood loss, and so on.

The system then trains the neural network using the respective losses for the training input sequences, e.g., by computing a gradient of an overall loss function that is a combination or a weighted combination of the respective losses and then applying an optimizer, e.g., Adam, AdamW, rmsProp, Adafactor, and so on, to the gradient to update the parameters of the neural network.

A “separator token” is a designated token that has been inserted into an original input sequence in order to indicate a separation between different components of the input sequence. For example, when the training sequences include an original input sequence followed by an original output sequence, the separator token(s) can include a beginning of sequence (BOS) token that is inserted before the original output sequence, i.e., to indicate that the neural network is expected to begin generating an output sequence and that the input is finished. When the training sequence include an original input sequence and no original output sequence, the separator token(s) can include a beginning of sequence (BOS) token that is inserted at the end of the training sequence, i.e., to indicate that the neural network is expected to begin generating an output sequence once the last token in the training sequence has been processed.

As another example, during the one or more final training phases in the sequence, the temperature of the local attention mechanisms, the global attention mechanisms, or both has been scaled as a function of preceding sequence length for each input position in each of the input training sequences.

That is, the training system can scale the temperature of the softmax function that is applied to initial attention weights computed by a given attention mechanism for a given input based on how many input positions precede the input position in the input training sequence, e.g., by decreasing the temperature with an increasing number of input positions. That is, the temperature can be the output of a function that is decreasing with respect to the number of preceding input positions, e.g., a function in the form of a/j^{b}, where a and be are constants and j is the number of preceding input positions, or another appropriate decreasing function. For example the temperature can be defined by a parameter T in a softmax function

$${e}^{{z}_{i} / T} / {\sum }_{j = 1}^{K} {e}^{{z}_{j / T}}$$

where zᵢ is an initial attention weight, and K is the total number of attention weights. As a result, positions later in the sequence will have sharper distributions (as opposed to using a default temperature, e.g., a default temperature of 1), causing an improvement in noise filtering.

FIG. 2A is a flow diagram of an example process 200 for processing an input sequence using the neural network. For convenience, the process 200 will be described as being performed by a system of one or more computers located in one or more locations. For example, a neural network system, e.g., the neural network system 100 depicted in FIG. 1C, appropriately programmed in accordance with this specification, can perform the process 200.

In particular, FIG. 2A is an example of the processing performed by the system when the neural network includes one or more global attention layers that have attention mechanisms that do not apply position encoding.

When the system performs an auto-regressive generation task, i.e., the system can perform the process 200 at each time step of the generation process, i.e., so that the input sequence at each iteration of the process 200 includes the current output sequence as of the time step and the network output is a prediction of a token that follows an input token at a last input position in the input sequence. As described above, the tokens can generally represent data of any appropriate modality, e.g., text, audio, images, video, and so on.

When the system generates the output for a task in a single time step, the input sequence is the input sequence for the task and the network output is a prediction of the final output for the task.

The system receives an input sequence that includes a respective token at each of multiple input positions (step 202). For example, as described above, the tokens at the input positions can represent any appropriate input modality, e.g., text, audio, images, videos and so on. In some cases, the input sequence is a multi-modal input sequence that includes tokens representing multiple different modalities.

For example, each input token can be a vector of a specified dimensionality and can be generated by processing a corresponding input item representing a portion of the input text, audio, image, video, and so on, e.g., using an embedding layer of the neural network or a separate encoder neural network.

For example, when the input sequence includes tokens that represent a visual input, e.g., a video or an image, the system can receive the visual input and process the visual input using a visual encoder neural network to generate the tokens representing the visual input. For example, the visual encoder neural network can be a variant of a vision Transformer or of a convolutional neural and can generate either continuous or discrete tokens. Examples of visual encoders include VQ-VAE, ViT-VQGAN, NaViT, or CoCa. The visual encoder neural network can be pre-trained prior to the training of the attention neural network and then held fixed during the training of the attention neural network, can be pre-trained prior to the training of the attention neural network and then fine-tuned during the training of the attention neural network, or can be trained from scratch jointly with the attention neural network. As another example, the system can generate the tokens representing the video input by applying a specified set of transformations to patches of the visual input, e.g., splitting, dimensionality reduction, quantization and so on.

For example, when the input sequence includes tokens that represent an audio input, the system can receive the audio input and process the audio input using an audio encoder neural network to generate the tokens representing the audio input. For example, the audio encoder neural network can include any one of BeST-RQ, aUSM encoder, a SoundStream encoder, or an AudioLM encoder. The audio encoder neural network can be pre-trained prior to the training of the attention neural network and then held fixed during the training of the attention neural network, can be pre-trained prior to the training of the attention neural network and then fine-tuned during the training of the attention neural network, or can be trained from scratch jointly with the attention neural network. As another example, the system can generate the tokens representing the audio input by applying a specified set of transformations to segments of the audio input, e.g., splitting, dimensionality reduction, quantization and so on.

When the input sequence is a multi-modal input sequence that includes tokens representing multiple different modalities, the tokens can be arranged within the input sequence in any appropriate way. In some cases, the sequence can include tokens of one modality followed by tokens of another modality. For example, when the sequence represents a text question about an input of another modality, e.g., audio, images, or video, the tokens representing the input of the other modality can be followed by the tokens representing the text question in the input sequence. In some cases, the sequence can include tokens of multiple modalities interleaved with one another. For example, the sequence can represent a multi-modal query that uses one modality to make multiple references to instances of data of another modality, e.g., “In this image [image 1], the cat is in the suitcase. Where is it in this image? [image 2].” In this example, the tokens for the different modalities can be interleaved to provide context as to which tokens of one modality refer to which tokens of the other modality.

By being trained on multi-modal sequences arranged as described above, the neural network can effectively process different input sequences with different arrangements of input tokens from different modalities after training.

When the network outputs generated by the system are predictions of tokens, this can refer to a prediction of the input item represented by the token, e.g., so that the system can generate outputs that include text, images, audio, or videos or multi-modal outputs.

When the network

The system then processes the input sequence using the neural network to generate a network output (step 204).

As described above, the neural network includes a plurality of layers that include a plurality of attention layers.

For example, the neural network can be a decoder-only neural network that includes a sequence of layers, with some of the layers being attention layers.

Generally, each attention layer receives a respective hidden state for each of the input positions and updates the respective hidden states for each of the input positions by applying an attention mechanism to the respective hidden states. As described above, when hidden states or keys and values are cached rather than being re-computed at every time step, updating the respective hidden states for each of the input positions by applying an attention mechanism to the respective hidden states refers to updating the respective hidden state for the last input position in the current input sequence using keys and values or hidden states for the other input positions that have been retrieved from memory.

The plurality of attention layers include a plurality of global attention layers and a plurality of local attention layers.

In the example of FIG. 2A, the partial position encoding scheme specifies that the respective local attention mechanisms applied by the plurality of local attention layers apply position encoding while the respective global attention mechanisms applied by each global attention layer in a subset that includes one or more of the plurality of global attention layers do not apply position encoding.

Thus, as part of performing step 204, for each local attention layer, the system processes the respective hidden states for each of the input positions that are received as input by the local attention layer and updates the respective hidden states for each of the input positions by applying a local attention mechanism that uses position encoding to the respective hidden states (step 206).

For each global attention layer that is in the subset, the system processes the respective hidden states for each of the input positions that are received as input by the global attention layer and updates the respective hidden states for each of the input positions by applying a global attention mechanism that does not use position encoding to the respective hidden states (step 208).

When the subset is a so-called “proper subset”, i.e., includes less than all of the global attention layers, for each global attention layer that is not in the subset, the system processes the respective hidden states for each of the input positions that are received as input by the global attention layer and updates the respective hidden states for each of the input positions by applying a global attention mechanism that does use position encoding to the respective hidden states.

FIG. 2B is a flow diagram of another example process 250 for processing an input sequence using the neural network. For convenience, the process 250 will be described as being performed by a system of one or more computers located in one or more locations. For example, a neural network system, e.g., the neural network system 100 depicted in FIG. 1C, appropriately programmed in accordance with this specification, can perform the process 250.

In particular, FIG. 2B is an example of the processing performed by the system when the neural network includes one or more global attention layers that have attention mechanisms that only apply position encoding to a proper subset of the dimensions of the input hidden states.

The system receives an input sequence that includes a respective token at each of multiple input positions (step 252). For example, as described the tokens at the input positions can represent any appropriate input modality, e.g., text, audio, images, videos and so on. In some cases, the input sequence is a multi-modal input sequence that includes tokens representing multiple different modalities.

The system then processes the input sequence using a neural network to generate a network output (step 254).

As described above, the neural network includes a plurality of layers that include a plurality of attention layers.

For example, the neural network can be a decoder-only neural network that includes a sequence of layers, with some of the layers being attention layers.

Generally, each attention layer receives a respective hidden state for each of the input positions and updates the respective hidden states for each of the input positions by applying an attention mechanism to the respective hidden states. Each hidden state is a respective vector having a specified dimensionality, i.e., a specified number of dimensions. The dimensionality of the hidden states can be the same as or different from the dimensionality of the input tokens.

As described above, when hidden states or keys and values are cached rather than being re-computed at every time step, updating the respective hidden states for each of the input positions by applying an attention mechanism to the respective hidden states refers to updating the respective hidden state for the last input position in the current input sequence using keys and values or hidden states for the other input positions that have been retrieved from memory.

The plurality of attention layers include a plurality of global attention layers and a plurality of local attention layers.

In the example of FIG. 2B, the partial position encoding scheme specifies that the respective local attention mechanisms applied by the plurality of local attention layers apply position encoding while the respective global attention mechanisms applied by each global attention layer in a subset that includes one or more of the plurality of global attention layers do not apply position encoding to one or more of the dimensions of the hidden states. That is, each global attention layer in a subset that includes one or more of the plurality of global attention layers apply position encoding to only a proper subset of the dimensions of the hidden states. For example, the proper subset can include one quarter, one half, or three quarters of the dimensions.

Thus, as part of performing step 254, for each local attention layer, the system processes the respective hidden states for each of the input positions that are received as input by the local attention layer and updates the respective hidden states for each of the input positions by applying a local attention mechanism that uses position encoding to the respective hidden states (step 256).

For each global attention layer that is in the subset, the system processes the respective hidden states for each of the input positions that are received as input by the global attention layer and updates the respective hidden states for each of the input positions by applying a global attention mechanism that does not apply position encoding to one or more of the dimensions of the hidden states (step 258).

When the subset is a proper subset, i.e., includes less than all of the global attention layers, for each global attention layer that is not in the subset, the system processes the respective hidden states for each of the input positions that are received as input by the global attention layer and updates the respective hidden states for each of the input positions by applying a global attention mechanism that does use position encoding for all of the dimensions of the respective hidden states.

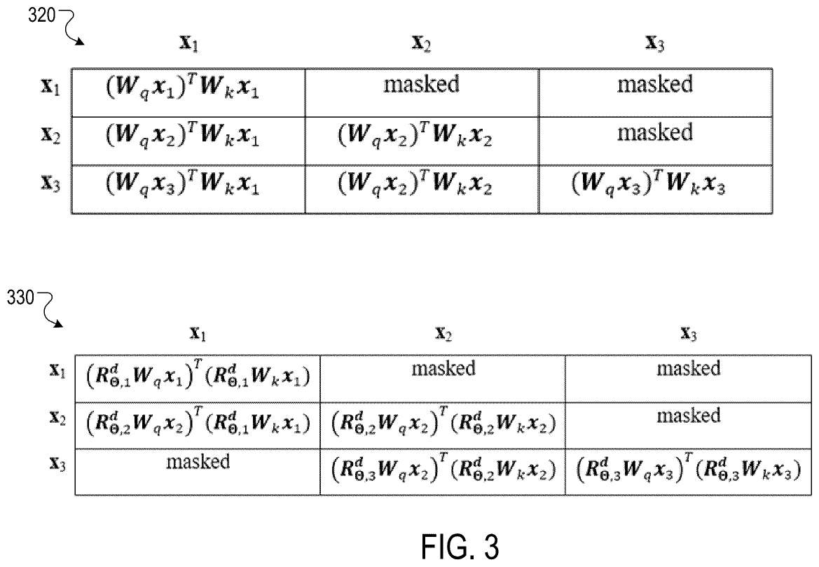

FIG. 3 is a diagram 300 that shows an example of the operations performed by a global attention head 320 of a global attention layer 120 and a local attention head 330 of a local attention layer 130.

In particular, in the example of FIG. 3, the global attention head 320 does not use position encoding while the local attention head 330 does.

More specifically, FIG. 3 shows the pre-softmax attention weights computed by the global and local attention heads 320 and 330 for an input sequence that has three input positions when the local window includes one position that precedes each position in the input sequence. That is, the rows of the diagram 300 correspond to query positions and the columns correspond to key positions, e.g., so that the entry at cell (x₃, x₂) represents the pre-softmax attention weights between the query at position 3 and the key at position 2.

Because the attention mechanism applied by both the local and global attention layers are causal, the entries above the diagonal are “masked,” i.e., set to values that will result in the post softmax weight being zero. In practice, the system can implement this masking in any of a variety of ways that result in the values corresponding to the masked out entries not contributing to the corresponding weighted sum when applying attention weights.

Additionally, because position 1 is outside the local window for position 3, the entry at cell (x₃, x₁) for the local attention head 330 is also masked.

As can be seen from FIG. 3, both attention heads 320 and 330 compute the attention weights from a respective query matrix W_{q} and a respective key matrix Wₖ.

However, because the local attention head 330 uses position encoding (and, more specifically, RoPE), the local attention head 330 also uses respective rotary matrices

$${R}_{Θ , m}^{d}$$

for each position m in the input sequence. The global attention head 320 does not use the rotary matrices

$${R}_{Θ , m}^{d}$$

when computing attention weights.

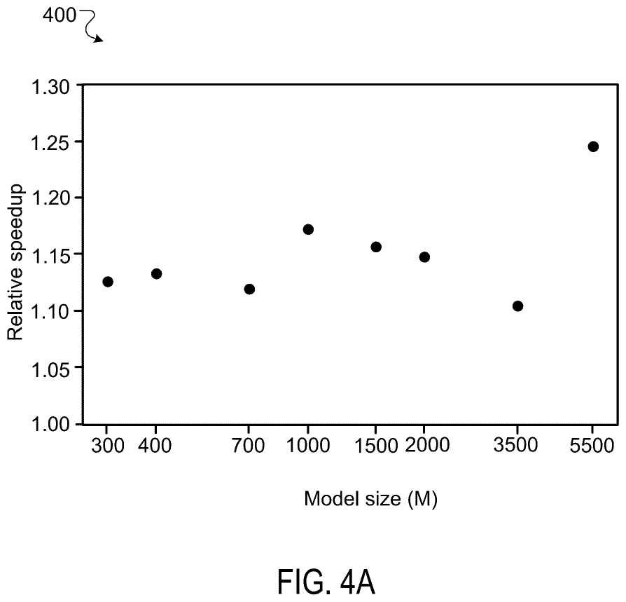

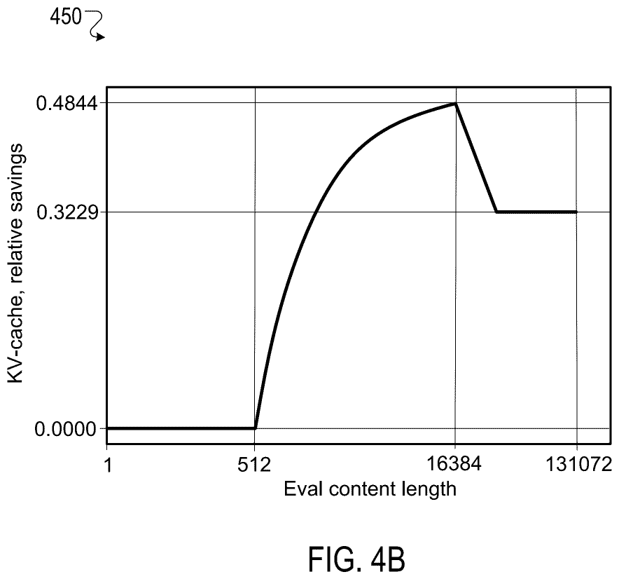

FIG. 4A is an example chart 400 that shows the performance of the described techniques. In particular, the chart 400 shows the relative speedup achieved as a result of using the partial position encoding scheme that removes position encoding from all global attention layers relative to a model that uses position encoding for all attention layers at various model sizes (in terms of millions of parameters (“M”). That is, the chart 400 shows the relative speedup, when deployed on the same hardware, between a given model that uses the partial position encoding scheme and another model that has the same architecture but uses position encoding for all attention layers. In particular, the speedup is achieved because the model that has the partial position encoding scheme can use a smaller local window than the other model while still maintaining the same or better performance, i.e., as a result of the partial position encoding scheme being used. As can be seen from the chart 400, making use of the described scheme significantly speeds up inference across a range of model sizes.

FIG. 4B is an example chart 450 that shows the performance of the described techniques. In particular, the chart 450 shows the performance of performing inference using a neural network that has the described position encoding scheme when caching keys and values in a “KV cache” during inference. More specifically, the chart 450 shows the reduction in the size of the KV cache when position encoding is removed from all global attention layers of a given model for various input sequence lengths (“context lengths”). As can be seen from the chart 450, making use of the described techniques results in significant savings when the context length exceeds 512 tokens, as is typically required for many real-world sequence processing tasks.

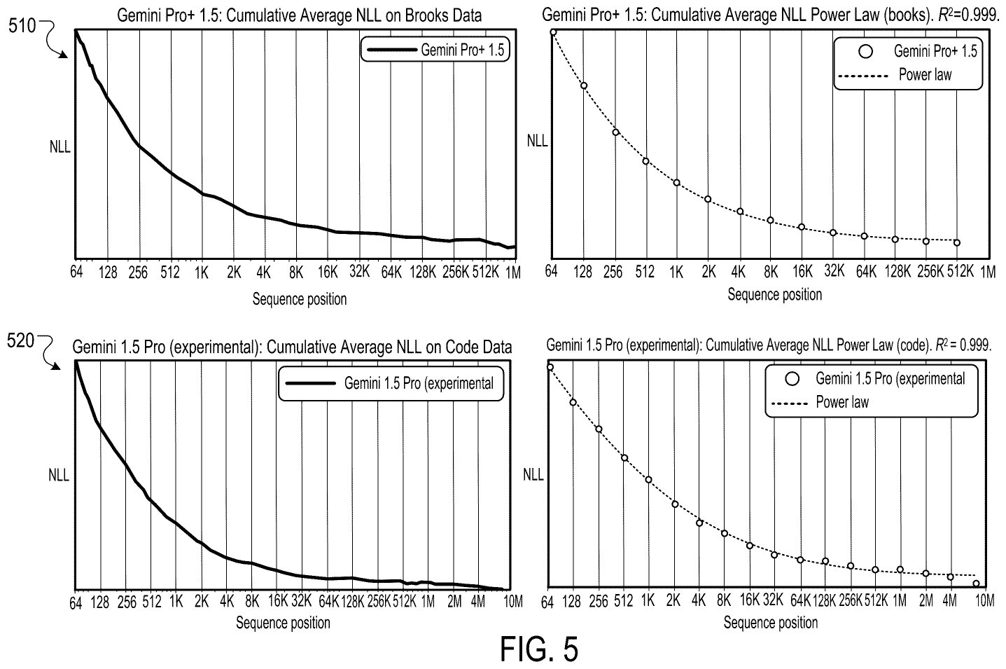

FIG. 5 shows an example 500 of the performance of the described techniques on the text modality, i.e., when processing input sequences that have input tokens that represent text. In example 500, the task is to predict the next token in the input sequence given the preceding tokens in the input sequence, i.e., next token prediction.

In particular, to evaluate the ability of the language model neural network to make use of very long context, the example 500 shows the negative log-likelihood (NLL) of tokens at different positions in the input sequence. Tokens at the beginning of a sequence are expected to have high NLL, as there is little to no context that the model can use to predict them, and tokens later in the sequence are expected to have lower NLL. The shape of the resulting curve indicates the abilities of models to reason over long context. A downward trend signifies models making use of long context to reduce models' uncertainty. On the other hand, an upward trend indicates that models are unable to effectively use information from the previous context indicating the limitations in their long context understanding capability.

The example 500 includes a first set of plots 510 for a dataset of books with lengths up to 1 million tokens, and a second set of plots 520 for a dataset with source code repositories where all source files were concatenated, e.g., by first randomly shuffling all the files and then concatenating them.

Since the code dataset contains sequences longer than 1 million tokens with some natural form of semantic association (e.g., a whole repository), it can be used to further evaluate even longer lengths up to 10M tokens.

Both the first set of plots 510 and the second set of plots 520, includes a first plot that shows cumulative NLL up to a specific token index and a second plot that fits a power law of the form

$$L ( x ) = \frac{{x}^{β}}{α} + γ$$

to the data shown in the first plot (shown in log-log plot), where α, β, and γ are the fitted parameters.

As can be seen from the plots, the NLL keeps decreasing almost monotonically up to the tested lengths (1M for books, and 10M for code), indicating that the language model neural network can make use of the whole input even at very long context lengths. From the second set of plots, it can be seen that NLL keeps decreasing even past the 1M tokens for code; this suggests that the model is able to keep improving its predictions by finding useful patterns in tokens even when these are further than 1M tokens away from the one currently predicting.

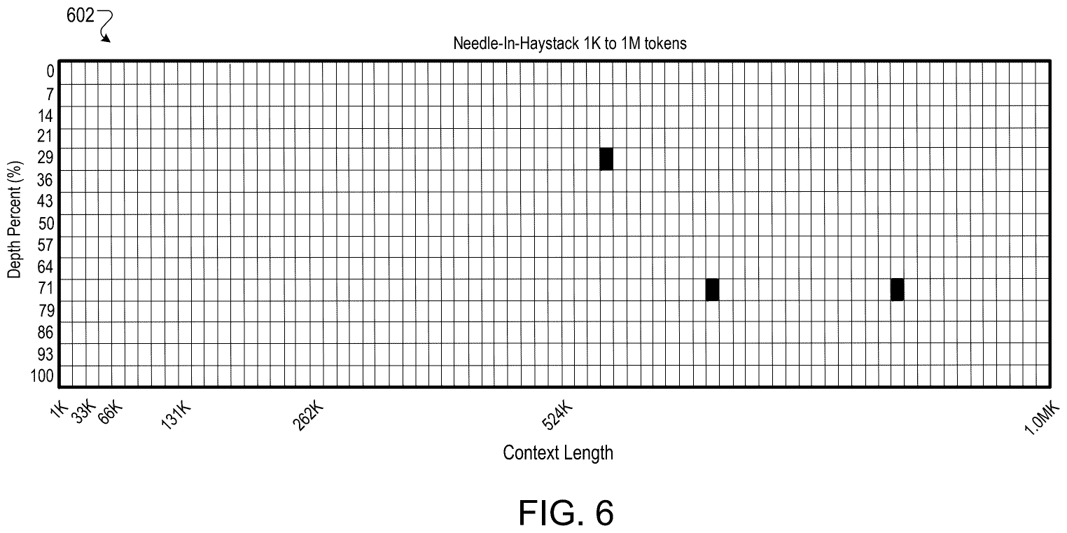

FIG. 6 shows an example 600 of the performance of the described techniques on another text processing task. In particular, FIG. 6 shows the performance of the described techniques on a task that requires retrieving text that has been inserted at various positions in an input sequence.

To generate the data for this task, at linearly spaced intervals from the beginning to the end of the context, the system inserts a “needle,” i.e., “The special magic {city}number is: {number}” where the city and number are varied for each query. To cause the language model to retrieve the needle, the system can also include a prompt at the end of the input sequence, e.g., “Here is the magic number:”

FIG. 6 includes a plot 602 that indicates whether the magic number recall was correct at various context lengths (x axis) as a function of its position in the input sequence expressed in terms of depth percentage (y axis), e.g., depth at 100% would indicate a needle inserted at the very end of the input whereas 0% at the very beginning. In the plot the three darker regions indicate where the system was unsuccessful; in the remainder of the plot the system was successful.

As can be seen in the plot 602, by making use of the described techniques, the system achieves >99% recall up to 1M tokens. This task provides a clear demonstration that the language model neural network is able to reliably retrieve information from long documents up to 1M tokens.

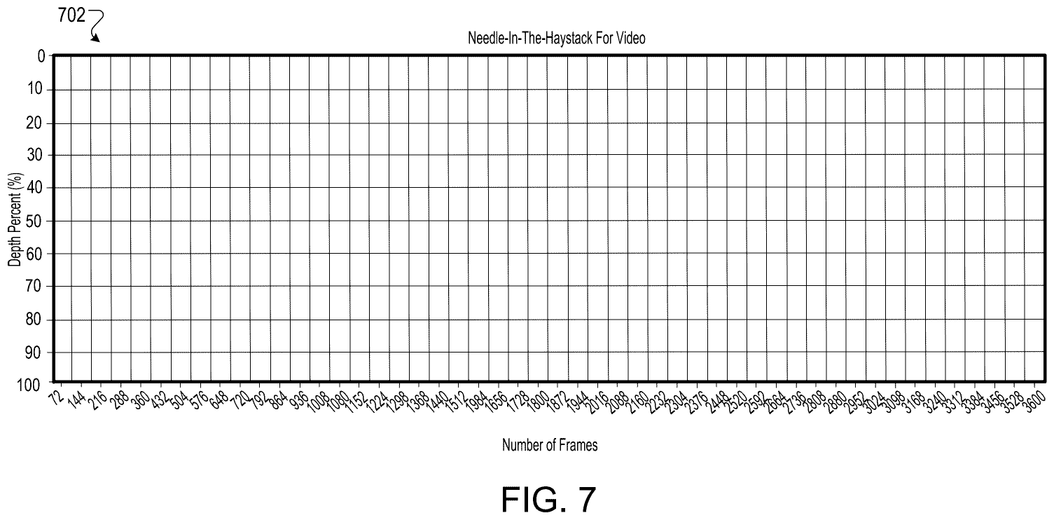

FIG. 7 shows an example 700 of the performance of the described techniques on a cross-modal data processing task. In particular, FIG. 7 shows the performance of the described techniques on a task that requires retrieving text that has been inserted at various positions in an input video. In other words, for this task, the system asks the model to retrieve information embedded in a random frame (the “needle”) in a long video (the “haystack”) instead of asking the model to retrieve a randomly inserted string from a corpus of text. The task is “cross-modal” because the “needle” is embedded in one modality (video) and the model needs to provide the answer in another modality (text).

FIG. 7 includes a plot 702 that that indicates whether the recall was correct at various context lengths, where the x-axis ranges across the maximum number of frames and the y-axis across the depth-percentage, i.e., the percentage of the length of the video where the needle is randomly inserted. For example, the very top left grid cell represents providing the model with the first 72 frames and randomly sampling a frame in the first ten percent of that trimmed video (i.e., frames 0, 1, . . . , 7) to insert the needle. As can be seen from the plot 702, the language model neural network can support an hour of video and successfully retrieves the embedded information across all context lengths and depth percentages shown in the plot 702 (FIG. 7 lacks any darker regions where the model was unsuccessful).

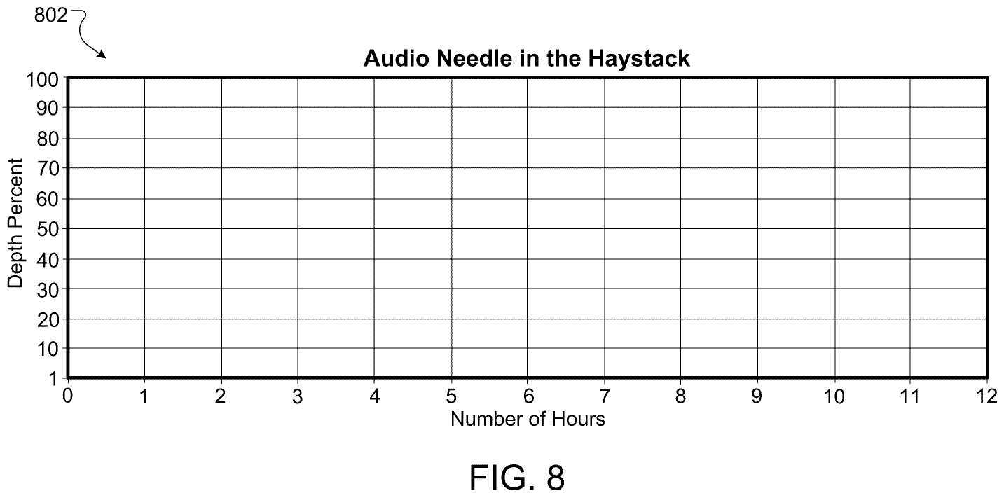

FIG. 8 shows an example 800 of the performance of the described techniques on another cross-modal data processing task. In particular, FIG. 8 shows the performance of the described techniques on a task that requires retrieving speech that has been inserted at various positions in an audio signal. In other words, for this task, the system asks the model to retrieve information embedded at a random time point (the “needle”) in a long audio signal (the “haystack”) instead of asking the model to retrieve a randomly inserted string from a corpus of text. The task is “cross-modal” because the “needle” is embedded in one modality (audio) and the model needs to provide the answer in another modality (text). To further challenge the model beyond increasing context, the large audio signal is built by concatenating samples from an unsupervised dataset so that the input signal contains multiple speakers.

FIG. 8 includes a plot 802 that shows the results when the input audio ranges from 1 hour to 11 hours, inserting the needle in different positions across the signal. Similar to the text and video evaluations, the model is always able to locate the embedded information in the input audio, independently of its position (FIG. 8 lacks any darker regions where the model was unsuccessful).

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, e.g., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, e.g., inference, workloads.

Machine learning models can be implemented and deployed using a machine learning framework, e.g., a TensorFlow framework or a Jax framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A method performed by one or more computers, the method comprising:
receiving an input sequence comprising a respective input token at each of a plurality of input positions; and
processing the input sequence using a neural network to generate a network output for a machine learning task, wherein:
the neural network comprises a plurality of layers that comprise one or more global attention layers and a plurality of local attention layers,
the plurality of layers are arranged in a sequence and each of the one or more global attention layers is preceded by a respective subset of the plurality of local attention layers in the sequence of layers,
each global attention layer receives a respective hidden state for each of the plurality of input positions and updates a respective hidden state for each of at least one of the plurality of input positions based on applying a global attention mechanism that, for each of at least one of the plurality of input positions, attends over all of the plurality of input positions preceding or equal to the input position in the input sequence,
each local attention layer receives a respective hidden state for each of the plurality of input positions and updates a respective hidden state for each of at least one of the plurality of input positions based on applying a local attention mechanism that, for each of at least one of the plurality of input positions, attends only over a set of local input positions that are within a local window of the input position in the input sequence,
the local attention mechanism applied by each local attention layer uses position encoding, and
the global attention mechanism applied by each global attention layer does not use the position encoding.

2. The method of claim 1, wherein each of the one or more global attention layers is preceded by a fixed number of respective local attention layers in the sequence of layers.

3. The method of claim 2, wherein the fixed number is three.

4. The method of claim 1, wherein the plurality of layers further comprise one or more Mixture of Experts (MoE) layers.

5. The method of claim 1, wherein the plurality of layers further comprise one or more dense feedforward layers.

6. The method of claim 1, wherein the position encoding comprises a Rotary Position Embedding (RoPE) position encoding.

7. The method of claim 1, wherein a number of input positions in the local window is less than or equal to 1.0% of a number of input positions in the input sequence.

8. The method of claim 1, wherein a number of input positions in the local window is less than or equal to 0.1% of a number of input positions in the input sequence.

9. The method of claim 1, wherein the respective input tokens at the plurality of input positions comprise tokens representing one or more of audio data, image data, or text data.

10. The method of claim 1, wherein the machine learning task comprises a multi-modal task that requires processing two or more of: audio data, image data, or text data.

11. The method of claim 1, wherein the machine learning task comprises a long context task that requires processing a long input sequence comprising at least one million input tokens.

12. A system comprising one or more computers and one or more storage devices storing instructions that when executed by the one or more computers cause the one more computers to perform operations comprising:
receiving an input sequence comprising a respective input token at each of a plurality of input positions; and
processing the input sequence using a neural network to generate a network output for a machine learning task, wherein:
the neural network comprises a plurality of layers that comprise one or more global attention layers and a plurality of local attention layers,
the plurality of layers are arranged in a sequence and each of the one or more global attention layers is preceded by a respective subset of the plurality of local attention layers in the sequence of layers,
each global attention layer receives a respective hidden state for each of the plurality of input positions and updates a respective hidden state for each of at least one of the plurality of input positions based on applying a global attention mechanism that, for each of at least one of the plurality of input positions, attends over all of the plurality of input positions preceding or equal to the input position in the input sequence,
each local attention layer receives a respective hidden state for each of the plurality of input positions and updates a respective hidden state for each of at least one of the plurality of input positions based on applying a local attention mechanism that, for each of at least one of the plurality of input positions, attends only over a set of local input positions that are within a local window of the input position in the input sequence,
the local attention mechanism applied by each local attention layer uses position encoding, and
the global attention mechanism applied by each global attention layer does not use the position encoding.

13. The system of claim 12, wherein each of the one or more global attention layers is preceded by a fixed number of respective local attention layers in the sequence of layers.

14. The system of claim 13, wherein the fixed number is three.

15. The system of claim 12, wherein the plurality of layers further comprise one or more Mixture of Experts (MoE) layers.

16. The system of claim 12, wherein the plurality of layers further comprise one or more dense feedforward layers.

17. The system of claim 12, wherein the position encoding comprises a Rotary Position Embedding (RoPE) position encoding.

18. The system of claim 12, wherein the respective input tokens at the plurality of input positions comprise tokens representing one or more of audio data, image data, or text data.

19. The system of claim 12, wherein the machine learning task comprises a multi-modal task that requires processing two or more of: audio data, image data, or text data.

20. One or more non-transitory computer storage media storing instructions that when executed by one or more computers cause the one more computers to perform operations comprising:
receiving an input sequence comprising a respective input token at each of a plurality of input positions; and
processing the input sequence using a neural network to generate a network output for a machine learning task, wherein:
the neural network comprises a plurality of layers that comprise one or more global attention layers and a plurality of local attention layers,
the plurality of layers are arranged in a sequence and each of the one or more global attention layers is preceded by a respective subset of the plurality of local attention layers in the sequence of layers,
each global attention layer receives a respective hidden state for each of the plurality of input positions and updates a respective hidden state for each of at least one of the plurality of input positions based on applying a global attention mechanism that, for each of at least one of the plurality of input positions, attends over all of the plurality of input positions preceding or equal to the input position in the input sequence,
each local attention layer receives a respective hidden state for each of the plurality of input positions and updates a respective hidden state for each of at least one of the plurality of input positions based on applying a local attention mechanism that, for each of at least one of the plurality of input positions, attends only over a set of local input positions that are within a local window of the input position in the input sequence,
the local attention mechanism applied by each local attention layer uses position encoding, and
the global attention mechanism applied by each global attention layer does not use the position encoding.
